(19) United States
(12) Patent Application Publication
(10) Pub. No.: US 2008/0226227 A1
(43) Pub. Date: Sep. 18, 2008

(54) Privacy in an Optical Fiber Link

(75) Inventor: Wenxin Zheng, Ellicott City, MD (US)

Correspondence Address: BANNER & WITCOFF, LTD., 1100 13th STREET, N.W., SUITE 1200, WASHINGTON, DC, 20005-4051, US

(73) Assignee: TENVERA, INC., Franklin, TN (US)

(21) Appl. No.: 11/685,488

(22) Filed: Mar. 13, 2007

(51) Int. Cl. G02B 6/26

(52) U.S. Cl. 385/27

(57) ABSTRACT

Methods and apparatuses are described for providing privacy features on an optical fiber link. By providing such features, the effects on the optical fiber link by certain outside influences, such as acoustical waves, may be prevented from being remotely monitored from a position outside the link.

### BACKGROUND

Optical fiber networks are beginning to replace copper networks as the “last mile,” or final leg, of connectivity to homes for services such as telephone, Internet, and television programming. Although not yet ubiquitous, network providers such as telephone companies are actively working to provide a large number of customers with such an optical fiber connection in the near future. Providing an optical fiber connection to a customer typically requires physically installing optical fibers from a distribution point to the customer's location.

It is known that optical fibers are affected by external factors. In particular, external factors such as sound waves and temperature can dynamically affect the optical properties of an optical fiber. It has more recently been discovered that, even when buried deeply underground, the optical properties of optical fibers can be measurably affected by sound above ground, such as by the voice of a person standing over the optical fiber. This is true even where the optical fiber is deeply buried such as six feet underground. It has been further shown that such optical property changes can be measured, thereby effectively allowing someone to listen in on a conversation occurring above ground or otherwise near an optical fiber.

### SUMMARY

The following presents a simplified summary of illustrative aspects in order to provide a basic understanding of various aspects described herein. This summary is not an extensive overview of the invention. It is not intended to identify key or critical elements of the invention or to delineate the scope of the invention. The following summary merely presents various concepts in a simplified form as a prelude to the more detailed description provided below.

For example, aspects provide for a method for modifying an optical fiber network of a service provider, wherein the optical fiber network includes a first optical fiber connected to an access point of a human-habitable customer building, the method comprising adding an optical blocker to the first optical fiber at a location that is in a range of 20 to 200 feet from the access point.

Further aspects provide for a network, comprising a plurality of optical pathways coupled to a plurality of customer locations; a distribution and switching center generating a plurality of optical signals for transmission to the plurality of customer locations over the plurality of optical pathways; at each of the customer locations, an optical connector terminating the respective optical pathway; and a plurality of optical blockers physically separate from the optical connectors, each located along one of the optical pathways at a location closer to the optical connector of the respective customer location than to the distribution and switching center.

Still further aspects provide for an apparatus for providing a secure region, comprising a first optical fiber segment; a second optical fiber segment disposed in the secure region; a third optical fiber segment; a first optical blocker optically coupling the first optical fiber segment to a first end of the second optical fiber segment; and a second optical blocker optically coupling an opposite second end of the second optical fiber segment to the third optical fiber segment.

These and other aspects of the disclosure will be apparent upon consideration of the following detailed description of illustrative aspects.

### BRIEF DESCRIPTION OF THE DRAWINGS

A more complete understanding of the present disclosure may be acquired by referring to the following description in consideration of the accompanying drawings, in which like reference numbers indicate like features, and wherein:

FIG. 1 is a cross-sectional view of a portion of an optical fiber, illustrating how acoustic waves can affect the optical properties of the optical fiber.

FIG. 2 is a cross-sectional view of an illustrative secure unidirectional optical fiber service to a human-habitable building.

FIG. 3 is a cross-sectional view of an illustrative secure bidirectional optical fiber service to a human-habitable building.

FIG. 4 is a top view of a network including an illustrative secure bidirectional optical fiber service to each of a plurality of human-habitable buildings.

FIG. 5 is a functional block diagram of an illustrative secured unidirectional optical fiber service to a human-habitable building.

FIG. 6 is a functional block diagram of an illustrative secured bidirectional optical fiber service to a human-habitable building.

FIG. 7 is a functional block diagram of an illustrative unidirectional optical communication apparatus for providing a secure region.

FIG. 8 is a functional block diagram of an illustrative bidirectional optical communication apparatus for providing a secure region.

FIG. 9 is a flow chart of an illustrative method for modifying an existing optical fiber network to provide for additional security.

FIG. 10 is a cross-sectional view of an illustrative unidirectional secure fiber connection.

FIG. 11 is a cross-sectional view of an illustrative bidirectional secure fiber connection.

FIG. 12 is another functional block diagram of an illustrative bidirectional optical communication apparatus for providing a secure region, including a filter.

FIG. 13 is yet another functional block diagram of an illustrative bidirectional optical communication apparatus for providing a secure region, including a pair of filters.

It is noted that the various drawings are not necessarily drawn to scale.

### DETAILED DESCRIPTION

The various aspects summarized previously may be embodied in various forms. The following description shows by way of illustration various examples in which the aspects may be practiced. It is understood that other examples may be utilized, and that structural and functional modifications may be made, without departing from the scope of the present disclosure.

As previously mentioned, sound waves, temperature, and other external factors affects the optical properties of an optical fiber. As will be seen, this may allow someone to remotely monitor these external factors in a region that surrounds an optical fiber. Although there are legitimate uses for such monitoring, there are also uses that are less desirable and potentially illegal.

For instance, in the case of “last mile” optical fiber connectivity, it would be fairly easy to monitor external factors surrounding the optical fiber running through a customer's land and up to the customer's home. This effectively means that someone could remotely monitor conversations by persons located on regions of the customer's land that are near the optical fiber. This is true even though the optical fiber may be buried underground. Presumably, very few if any customers would knowingly consent to such monitoring.

A particularly striking example of another illegitimate monitoring situation is where the customer is a government facility, such as a military base, where classified or other sensitive information is handled. It is conceivable that a terrorist organization or other enemy could listen to conversations occurring on government property near a buried optical fiber. Although typically procedures are in place that limit discussions of sensitive information, the possibility of optical fiber monitoring is yet another potential threat that would need to be dealt with.

As will be described in connection with various illustrative scenarios, an optical fiber link may be modified so as to reduce or even eliminate the possibility of remote monitoring of external factors. The modification may be implemented in a relatively inexpensive way. In a commercial environment, such a modification may additionally provide a source of revenue to a service provider or other network manager.

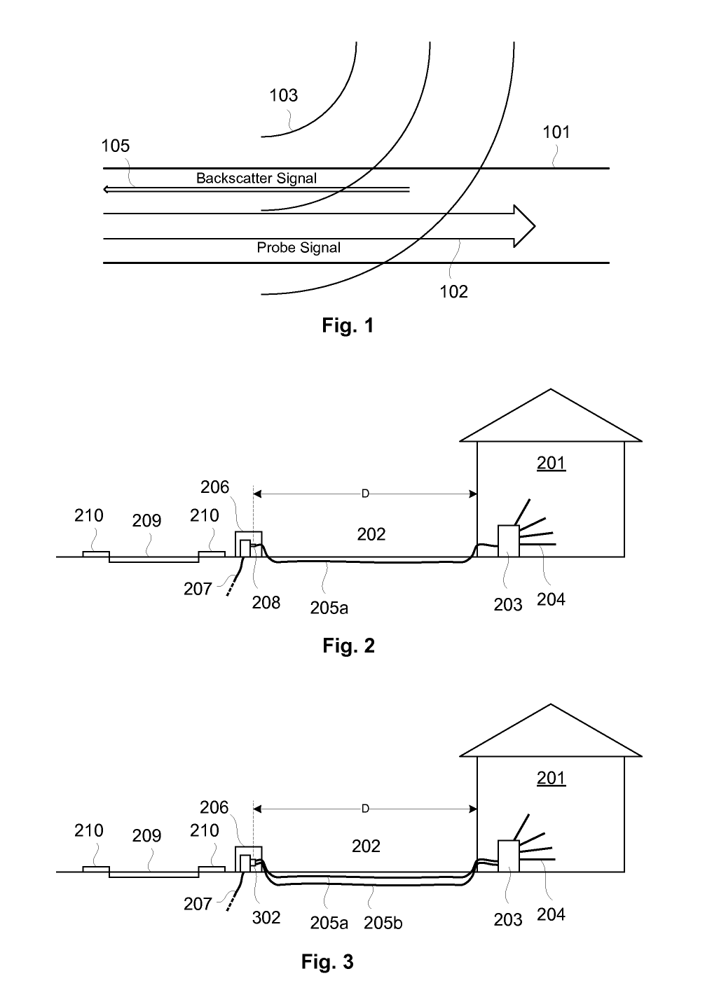

Before discussing various modifications, an illustrative method by which an optical fiber may be monitored will be described. Referring to FIG. 1, a simplified cross-sectional representation of an optical fiber 101 is shown. An acoustic wave 103 is incident on optical fiber 101. Acoustic wave 103 may be, for example, a nearby human voice or other acoustic source. Acoustic wave 103 causes optical fiber 103 to vibrate at one or more frequencies based on the frequencies of acoustic wave 103. This vibration causes the optical properties of optical fiber 101 to be modulated at the vibration frequencies. All optical pathways, other than a perfect vacuum, inherently provide for some backscattering (i.e., backward reflectivity) and/or absorption of light traveling through the pathway. In the of optical fiber 101, the vibration thereof causes alternating condensations and rarefactions at a molecular level within optical fiber 101, thereby causing the intensity of backscattering to be modulated in accordance with the frequencies of the vibration.

To monitor the varying backscattering intensity, a probe signal 102 may be used. More precisely, probe signal 102 is a light signal of any frequency that is transmitted through optical fiber 101. As optical fiber 101 vibrates, a small amount of probe signal 102 is reflected backward, resulting in a backscattering signal 105 that travels in a direction that is the reverse of probe signal 102. The backscattering signal 105 may have an amplitude, phase, and/or other optical properties that are modulated by the vibrations of optical fiber 101. The modulation of backscattering signal 105 may be measured using sophisticated equipment that is currently available.

FIG. 2 shows an illustrative “last mile” connection to a human-habitable building 201 of a customer (in this example, the customer's home). Building 201 is situated on a piece of property 202. In this example, a road 209 with sidewalks 210 runs along an edge of property 202. Underground, and typically parallel with road 209, runs a distribution optical fiber 207 that carries signals for a number of different customers along road 209. At various points along distribution optical fiber 207, a junction box 206 is provided that splits out the signals thereon to optical fibers that run to various ones of the customers. For instance, an optical fiber 205a is optically connected to optical fiber 205a, which provides an optical path to a service receiver 203 in building 201. Service receiver 203 converts the optical signals on optical fiber 205a to electrical signals for distribution on an internal network 204 (as electrical and/or optical signals), and so service receiver 203 may be considered an access point to building 201 and may provide optical termination of optical fiber 205a.

Normally, when a person is located near optical fiber 205a, such as on the ground above optical fiber 205a, and speaks, that person's voice will affect optical fiber 205a and thus be susceptible to remote monitoring using a probe signal via optical fiber 205a. To reduce or even prevent this threat, a blocking device may be provided in the optical path to building 201. The blocking device may serve to allow desired signals to pass through the optical path while reducing or even eliminating undesired signals (e.g., backscatter signals) that could be used for remote monitoring purposes.

In this example, distribution optical fiber 207 is optically connected to optical fiber 205a via an optical isolator 208. An optical isolator is a known device that allows optical signals to travel substantially only in one direction through the device; it is analogous to a one-way street. In this example, optical isolator 208 is configured so as to substantially block optical signals from traveling upstream from building 201 to distribution optical fiber 207, while allowing optical signals to travel downstream from distribution optical fiber 207 to building 201. Thus, the region near optical fiber 205a between optical isolator 208 and the termination/access point at service receiver 203 may be considered to be secure from remote optical fiber monitoring. This region may be of any size, however it may be expected that the customer would want to maximize the size of the region as much as possible or practical. Thus, it may be expected that the customer would desire for optical isolator 208 to be as far from building 201 as possible or practical. For instance, one practical location would be to place optical isolator 208 injunction box 206, which already exists in conventional optical “last mile” paths. In a typical installation, one may expect optical isolator 208 to be in the range of D=20 to 200 feet from building 201, however D may be shorter than 20 feet or longer than 200 feet.

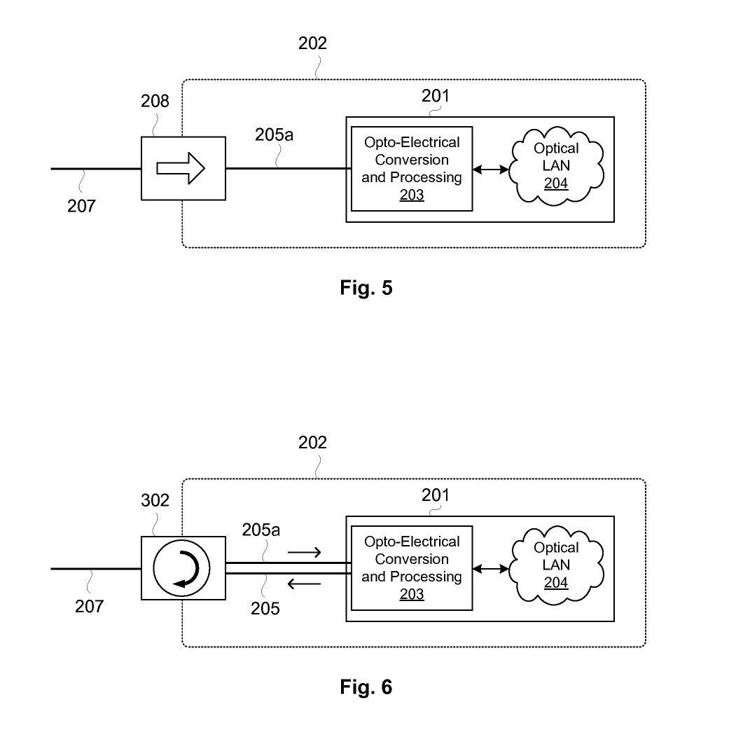

FIG. 5 shows a functional block diagram version of the configuration of FIG. 2. As can be seen, distribution optical fiber 207 feeds into an input of optical isolator 208, which in turn outputs to optical fiber 205a. Optical fiber 205a is optically connected to service receiver 203, which converts the downstream main signal provided on optical fiber 205a into an electrical signal. Then, service receiver 203 either distributes the electrical signal onto an electrical local area network (LAN), or as shown reconverts the electrical signal to an optical signal for distribution onto an optical LAN 204 within building 201.

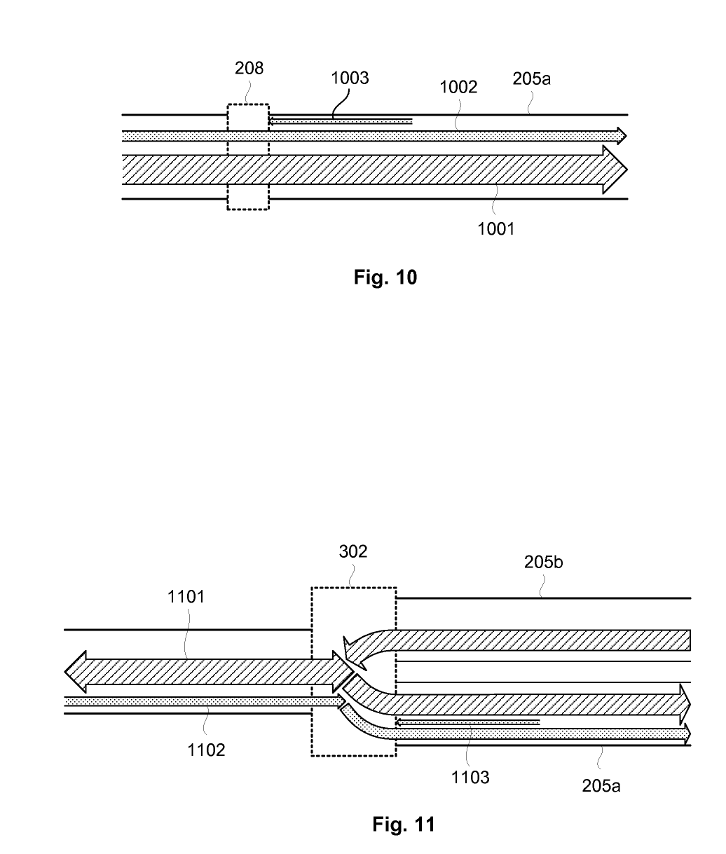

An example of how optical isolator 208 may provide a secured region is described with reference to FIG. 10. As shown, a main downstream signal 1001 provided by the service provider is able to pass through optical isolator 208. In addition a probe signal 1002 is shown as being able to pass through optical isolator 208 as well. However, a backscattering signal 1003, modulated due to interactions between optical fiber 205a and external factors, is unable to pass in the upstream direction through optical isolator 208. Thus, an entity that is remotely monitoring the external factors on optical fiber 205a will be unable to measure backscattering signal 1003 from a point upstream of optical isolator 208.

The above discussion has been in the context of a unidirectional downstream signal, such as a television signal. However, many services utilize bidirectional signals, such as Internet and telephone services. Accordingly, an example of how a bidirectional “last mile” secured connection may be configured is shown in FIG. 3. Here, optical isolator 208 is replaced with an optical circulator 302. Also an additional optical fiber 205b is added in parallel with optical fiber 205a. In this example, optical fiber 205a is intended exclusively for downstream signals and optical fiber 205b is intended exclusively for upstream signals. FIG. 5 shows a functional block diagram version of FIG. 3.

An optical circulator is a known device that has three nodes, one of which is bidirectional and two of which are unidirectional in opposing directions (i.e., outgoing and incoming). A signal that is sent into the bidirectional node is output only at the outgoing unidirectional node. A signal that is sent into the ingoing unidirectional node is output only at the bidirectional node. An optical circulator is analogous to a merge or split between a single two-way street and two separate one-way streets going in opposite directions.

An example of how optical circulator 302 may provide a secured region is described with reference to FIG. 11. As shown, a bidirectional main signal 1101 is able to pass through optical circulator 302 in the downstream direction only onto optical fiber 205a. In addition, bidirectional main signal 1101 is able to pass through optical circulator 302 in the upstream direction only from optical fiber 205b. Also, a probe signal 1102 is able to pass downstream in the same manner as bidirectional main signal 1101 by passing into optical fiber 205b. However, a backscattering signal 1103, modulated due to interactions between optical fiber 205a and external factors, is unable to pass in the upstream direction via optical fiber 205a, since the node of optical circulator 302 connected to optical fiber 205a is a downstream-only (or, in this example, outgoing) node. Thus, an entity that is remotely monitoring the external factors on optical fiber 205a will be unable to measure backscattering signal 1103 from a point upstream of optical circulator 302.

In both the bidirectional and unidirectional situations, it has been assumed that the modulated backscattering signal 1003 or 1103 is generated from backscattering of a probe signal separate from the main signal. However, a separate probe signal is not necessary for remote monitoring. Remote monitoring may be performed, for instance, of a backscattering signal generated from backscattering of the main signal (e.g., signal 1001 or 1101) itself.

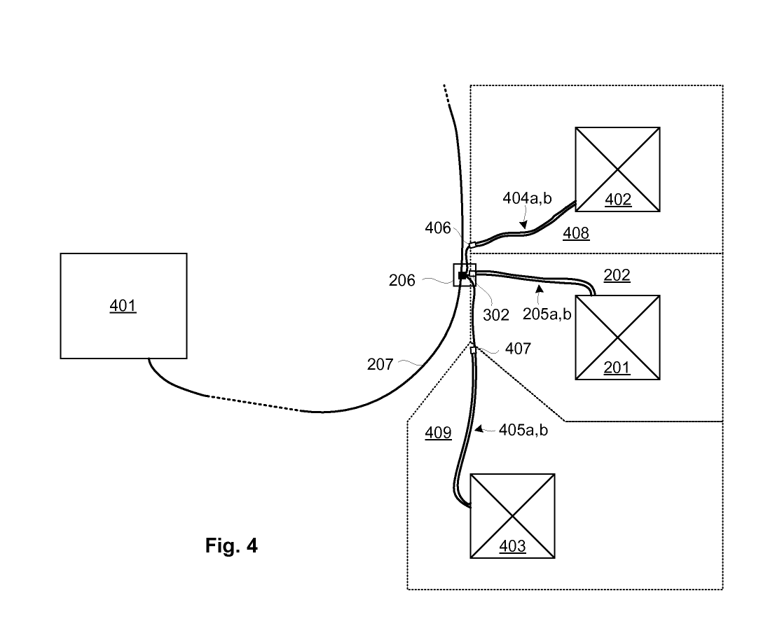

An overhead view of a set of bidirectional “last mile” links is illustratively shown in FIG. 4. Here, a distribution and switching center 401 of a service provider provides one or more optical fibers, such as optical fiber 207, to various locations. [Wenxin, is the distribution and switching center a standard central office or DSLAM as in a POTS system? Or do optical fiber networks use a different type of distribution/switching center? Also, is “distribution and switching center” a good name or is there a more appropriate one?] For instance, a different optical fiber may be sent to each of a number of neighborhoods or other geographical regions. In addition, for a given geographical region, a plurality of customers each has a human-habitable building 201, 402, 403 associated with a region of land 202, 408, 409. Each building 201, 402, 403 may be configured with an internal local network and service receiver such as the configuration of building 201 as shown in FIG. 2. Each customer may have its own blocking device, such as an optical circulator or an optical insulator. In the example shown, each customer has its own optical circulator 302, 406, 407 and its own pair of optical fibers 205a,b, 404a,b, 405a,b (one for downstream, one for upstream) running between respective optical circulator 302, 406, 407 and a terminal point in, on, or otherwise near respective building 201, 402, 403.

In the present example, each bidirectional optical path between optical fiber 207 and buildings 201, 402, 403 shares junction box 206. However, each of buildings 201, 402, 403 may have its own junction box. Moreover, each junction box may be on a customer's property or off the customer's property, as appropriate and practical. Property lines are illustratively shown in FIG. 4 as broken lines. The respective optical circulator or other blocking device for a particular customer may be located anywhere along the customer's optical path as desired. For instance, where the junction box associated with a customer is located off the customer's property, the blocking device may be located within junction box 206 (such as is optical circulator 302), or outside junction box 206 and on or near the customer's property line (such as are optical circulators 406 and 407), wholly within the customer's property, or wholly outside the customer's property. Although FIG. 4 shows a bidirectional configuration, the same setup may be used for a unidirectional (e.g., downstream only) configuration.

It may be reasonably expected that the distance (e.g., distance D in FIG. 2) between a customer building and its respective blocking device would be far less than the distance between the blocking device and distribution and switching center 401. Although this may not always be true, it may be reasonably expected, for instance, where the customer buildings are located on standard suburban residential lots, such as lots that are one acre or less. For example, it may be reasonably expected in many instances that the distance between a blocking device and its associated customer building would be in the range of under 200 feet, such as in the range of 20 to 200 feet, and that the distance between the blocking device and distribution and switching center 401 would be in the range of a half mile or more.

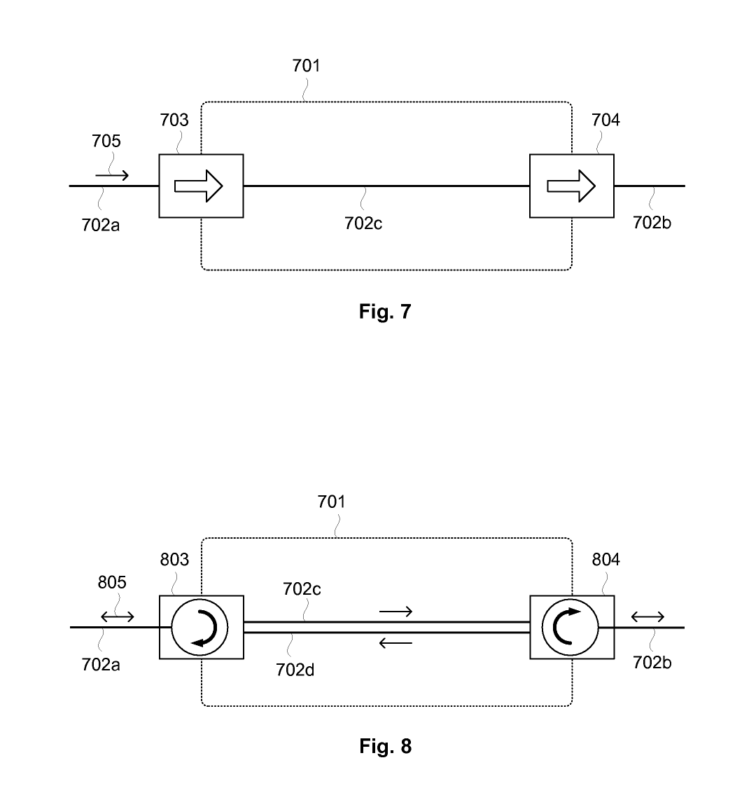

The customers of FIG. 4 are shown as being at terminal locations in a given link. For example, the optical link including optical fibers 205a,b terminate that the customer (more specifically in this example, at the customer's building 201. In another configuration, an optical link may pass through a customer's premises but not terminate at the premises. For instance, referring to FIGS. 7 and 8, a geographical region 701 may be defined that is to be protected from remote snooping via an optical fiber 702 that passes through region 701. Region 701 may be any region, such as private property, a military base, a government facility, a field, or any other region in/on land or water as desired. In this example, optical fiber 702 does not necessarily terminate within region 701, and instead merely passes through region 701.

It may be desirable to protect region 701 from remote snooping. For instance, there may be a concern that someone located outside of region 701 may try to listen in on someone located inside of region 701 by listening to the effects of sound waves on optical fiber 702 within region 701. To provide protection against this where a main signal 705 being sent along optical fiber 702 is a one-way signal, a pair of optical isolators 703, 704 may be inserted in series at or near the entrance to and exit from region 701 along optical fiber 702, as shown in FIG. 7. In this example, such an insertion effectively breaks up optical fiber 702 into three optical fibers: 701a and 701b outside region 701, and optical fiber 701c inside region 701. Using such a configuration, any backscattering originating within region 701 of main signal 705 or a co-directional probe signal would be prevented by optical isolator 703 from leaving region 701. Moreover, probe signal originating from outside region 701 and sent in the opposite direction as main signal 705 toward region 701 would be prevented from entering region 701 by isolator 704. Accordingly, a certain amount of privacy within region 701 may be attained.

Where a main signal 805 is bidirectional, then a pair of optical circulators 803, 804 may be inserted in series at or near the entrance to and exit from region 701 along optical fiber 702. In addition, optical fiber 702 between optical circulators 803, 804 may be divided into two parallel optical fibers 702c,d. Using such a configuration, any backscattering originating within region 701 on optical fiber 702c of main signal 805 or a co-directional probe signal would be prevented by optical circulator 803 from leaving region 701. And, any backscattering originating from region 701 on optical fiber 702d of main signal 805 or a co-directional probe signal would be prevented by optical circulator 804 from leaving region 701. Moreover, any probe signal attempting to pass into region 701 in an opposite direction on optical fiber 701c or 701d as main signal 805 will be prevented from entering region 701 by optical isolator 803 or 804. Accordingly, a certain amount of privacy within region 701 may be attained.

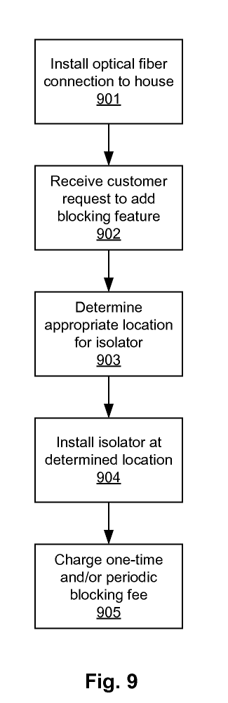

FIG. 9 shows an illustrative method for modifying an optical fiber link to potentially provide additional privacy to a customer. In step 901 an optical fiber connection to a customer, such as the customer's house, is installed. The installation may be above and/or under ground. Next, in step 902, a request from the customer may be received by the optical fiber network installer and/or a service provider on the optical fiber network to add a privacy feature to the optical link. The request may be made in person or by mail, or by electronic means such as by email or telephone. Next, in step 903, a trained optical fiber network technician, for example, may determine an appropriate location for one or more optical isolators and/or optical circulators, more generally referred to as optical blockers. If the optical link is unidirectional (e.g., downstream only), then optical isolators may be chosen. If the optical link is bidirectional, then optical circulators may be chosen. If the optical link terminates at the customer's location, then only a single optical blocker may be chosen. If the optical link passes through the customer, then a pair of series-installed optical blockers may be chosen. Regardless of the link configuration, the chosen location(s) may depend on one or more factors. For instance, the chosen location(s) may depend on the customer's and/or surrounding legal land boundaries, the location of any nearby junction box, and/or a customer indication of the boundary of a region that is requested to be protected.

Referring still to FIG. 9, in step 904 the one or more optical blockers may be installed in their chosen locations. Once installed, the owner, operator, and/or service provider (all of which may or may not be the same entity or related entities) of the optical network may charge the customer for the privacy protection feature (step 905). Such charges may be assessed in any manner desired. For instance, a one-time installation fee may be assessed and/or a periodic fee (e.g., monthly) may be assessed. This may allow customers the flexibility to spend less where privacy is not as important, or to choose to spend more where privacy is more important. This also gives service providers and/or network owners/operators a way to distinguish themselves from their competitors and to at least recover any costs associated with installing and/or otherwise providing such a privacy feature to customers. As an alternative to modifying an existing optical link, one or more optical blockers may be provided during original installation of the optical link. The same fee structure may apply as desired.

Any optical blocker as described herein may be provided as a dedicated optical blocker or integrated with another device performing a function other than optical blocking. In the dedicated configuration, the optical blocker may be, for instance, an optical isolator having a housing with an optical input and an optical output disposed at the housing (e.g., at opposite ends of the housing). In this configuration, no other device is disposed within the housing, and the input optical fiber and the output optical fiber may be connected directly to the optical input and output, respectively. In the integrated configuration, the optical blocker may be integrated with another device within the same housing and/or attached to the exterior of the housing.

It has been previously described how an optical isolator can prevent signals from traveling backwards through the optical isolator, and how an optical circulator can prevent certain signals from traveling in certain directions through the optical circulator. However, in practice an optical isolator or circulator may be more effective in some optical frequency ranges and less effective in others. Put another way, certain frequencies of optical signals may be blocked less than others. Accordingly, depending upon the frequency of any probe signal being used, the backscattering of the probe signal (which is typically at the same frequency of the probe signal) may be blocked to a greater extent or to a lesser extent. To provide even greater security in a situation where the probe signal is of a frequency substantially different from the frequency of the main signal, one or more filters may be added in series with an optical blocker. The filter may be physically separate from the optical blocker or may be integrated with the optical blocker as a single device with a single housing.

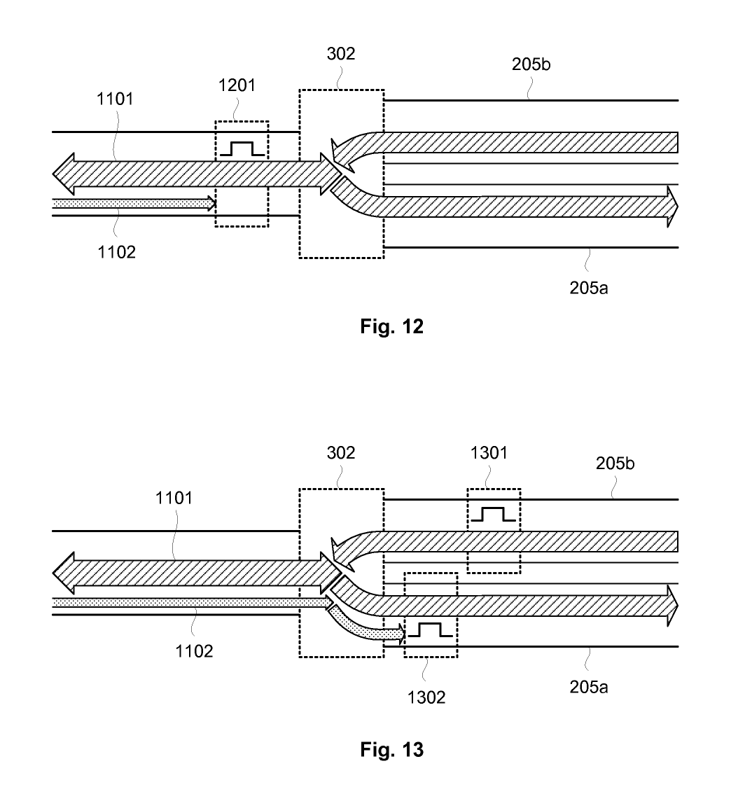

For example, referring to FIG. 12, a bandpass filter 1201 may be installed in series with optical circulator 302 as shown. Bandpass filter 1201 may be configured to allow signals that are the same frequency or frequencies of main signal 1101 to pass, while blocking most other frequencies substantially different from those frequencies. Typically, in a bidirectional link, the downstream and upstream frequencies are different to reduce the effects of backscatter sensitivity. In such a situation, bandpass filter 1201 may be configured to pass both the upstream and downstream main signal 1101 frequencies. Although a bandpass filter is used in this example, any other type of filter may be used as desired or otherwise appropriate, such as a low pass filter, a high pass filter, a notch filter, or even a more complex filter or series of filters. In the example of FIG. 12, bandpass filter 1201 is installed on the bidirectional port side of optical circulator 302. Thus, in this example bandpass filter 1201 would be a bidirectional filter.

However, filters may alternatively or additionally be installed at the unidirectional ports, such as shown in FIG. 13. Here, bandpass filters 1301, 1302 are installed in this configuration, and need only be unidirectional filters if desired (although bidirectional filters may be used in this example). As in the previous example, filters 1301, 1302 may be any type of filter as desired or otherwise appropriate.

Thus, methods and apparatuses for providing privacy features on an optical fiber link have been described. By providing such features, the effects on the optical fiber link by certain outside influences, such as acoustical waves, may be prevented from being remotely monitored from a position outside the link.

What is claimed is:

1. A method for modifying an optical fiber network of a service provider, wherein the optical fiber network includes a first optical fiber connected to an access point of a human-habitable customer building, the method comprising adding an optical blocker to the first optical fiber at a location that is in a range of 20 to 200 feet from the access point.

2. The method of claim 1, wherein the first optical fiber enters the customer building at the access point.

3. The method of claim 1, further including receiving a request from a customer associated with the customer building, wherein the step of adding is performed in response to the request.

4. The method of claim 1, further including determining the location based on a land property boundary associated with the customer building, such that the location is within an area enclosed by the land property boundary.

5. The method of claim 1, wherein the optical blocker is an optical circulator.

6. The method of claim 1, further including:
connecting a second optical fiber to the access point in parallel with the first optical fiber; and
adding the optical isolator to the first and second optical fibers, wherein the optical blocker is an optical circulator.

7. A network, comprising:
a plurality of optical pathways coupled to a plurality of customer locations;
a distribution and switching center generating a plurality of optical signals for transmission to the plurality of customer locations over the plurality of optical pathways;
at each of the customer locations, an optical connector terminating the respective optical pathway; and
a plurality of optical blockers physically separate from the optical connectors, each located along one of the optical pathways at a location closer to the optical connector of the respective customer location than to the distribution and switching center.

8. The network of claim 7, wherein each optical connector is physically connected to equipment at the respective customer location that converts the optical signal carried on the respective optical pathway to an electrical signal.

9. The network of claim 7, wherein each optical connector is located inside a human-habitable building at the respective customer location, and each optical isolator is located outside the respective human-habitable building.

10. The network of claim 7, wherein each optical blocker is located at a distance that is in a range of 20 to 200 feet from the respective optical connector.

11. The network of claim 7, wherein each optical blocker is a dedicated optical blocker disposed in a single housing.

12. The network of claim 7, wherein each of the optical blockers is an optical circulator.

13. An apparatus for providing a secure region, comprising:
a first optical fiber segment;
a second optical fiber segment disposed in the secure region;
a third optical fiber segment;
a first optical blocker optically coupling the first optical fiber segment to a first end of the second optical fiber segment; and
a second optical blocker optically coupling an opposite second end of the second optical fiber segment to the third optical fiber segment.

14. The apparatus of claim 13, wherein the second optical fiber segment is a single continuous optical fiber.

15. The apparatus of claim 13, wherein the second optical fiber segment is at least partially disposed underground.

16. The apparatus of claim 13, wherein the second optical fiber segment is at least 200 feet in length.

17. The apparatus of claim 13, further including a fourth optical fiber segment, wherein the first optical isolator optically couples the first optical fiber segment to a first end of the fourth optical fiber segment and the second optical blocker optically couples the third optical fiber segment to an opposite second end of the fourth optical fiber.

18. The apparatus of claim 17, wherein the second and fourth optical fiber segments are each a single continuous optical fiber.

19. The apparatus of claim 17, wherein the first and second optical blockers are each an optical circulator.

20. The apparatus of claim 13, wherein the second and fourth optical fiber segments are each at least 200 feet in length.
